(19) United States
(12) Patent Application Publication
(10) Pub. No.: US 2002/0095885 A1
(43) Pub. Date: Jul. 25, 2002

(54) Force resistant door and window framing system

(76) Inventor: Kenneth E. Sampson, Crownsville, MD (US)

Correspondence Address: Richard C. Litman, LITMAN LAW OFFICES, LTD., P.O. Box 15035, Arlington, VA, 22215, US

(21) Appl. No.: 09/767,745

(22) Filed: Jan. 24, 2001

(51) Int. Cl. E06B 1/04

(52) U.S. Cl. 52/202; 52/204.62; 52/208; 52/213; 52/204.5

(57) ABSTRACT

A force resistant door and window framing system has blast, forced entry, and ballistic resistant frame sections each formed of a single basic monolithic, homogenous steel component. Each section is extruded or drawn through a die to provide the desired cross sectional shape, incorporating features for precluding forced entry, whether by hand, ballistic firearm, or blast, at least to the limits of strength of the structure. The sections (jamb and header for doors, or stile, header, and sill for windows) are then welded at their mating ends to form a single, rigid structure, with an additional interior stop provided for the window within a window frame. The present invention is far superior to such structures of the prior art which are formed of a relatively large number of stock components, thus requiring extensive linear welds and resulting in a considerably heavier and yet weaker structure.

### BACKGROUND OF THE INVENTION

1. Field of the Invention

The present invention relates generally to building structures, and more specifically to door and window frames for such structures which provide resistance against ballistic, blast, and forced entry forces by extruding or drawing (the term “extrusion” will be understood to refer to both processes throughout the present disclosure) the frame members as monolithic components of homogeneous high strength steel material. The present door and window frames meet the requirements of State Department Standard 01.01, Revision G (Amended), using only a single basic homogeneous member for each sill, stile, jamb, and header member comprising the completed frame.

2. Description of the Related Art

The increasing need for greater physical security is evident in most parts of the world, both in the U.S. and abroad. Ever increasing threats of terrorism, breaking and entering, assaults with firearms, etc., have resulted in increasing concern for ways to meet or counter these threats and potentials. While building structures themselves can generally be constructed to withstand such forces, the weak points of such structures are generally the windows and doorways.

Accordingly, ever stronger door and window construction has been developed, using high strength steels, very thick and tough glass for ballistic resistance (i. e., “bulletproof”), and other refinements. In fact, the U.S. State Department has indicated its recognition of the need to provide force resistant doors and windows in many of their structures, according to State Department Standard 01.01, Revision G, as amended. This Standard prescribes requirements for various types of doors, windows, and other openings, for various levels of resistance to forced entry and ballistic (firearms) forces applied to such building components. While no specific structural requirements are described in this document, the performance requirements are quite stringent.

To this point, the State Department Standard 01.01 requirements have been met by constructing door and window frames of a relatively large number of separate stock steel components (rectangular tubes, angles, bar stock, etc.) and welding these components together to form built up jamb, stile, header, and sill members for doors and windows. Such construction is labor intensive, due to the need for essentially continuous welds along several linear joints along each length of material. Such construction also results in a quite heavy structure, due to the doubled thicknesses of various tube, angle, and bar stock components where they are welded together. Yet, due to the welded joints and the numerous separate components used for each member, the resulting structure is not as strong as such a member would be if formed of a single, monolithic, homogeneous piece of steel.

Accordingly, a need will be seen for a door and window framing system which is highly resistant to the forces imparted by blasts, ballistic impact, and attempted forced entry. The present system comprises door and window frames constructed of elongate jamb, stile, header, and sill members each formed as a monolithic, homogeneous high strength steel component, rather than being assembled (welded, etc.) from a series of stock steel components. All of the door frame members have identical cross sectional shapes to one another, as do the window frame members to one another, thus simplifying the manufacturing process. The members are cut to the appropriate length and welded together at their ends to form the completed door and window frame assemblies, with relatively little time and labor being involved in the relatively short end welds.

A discussion of the related art of which the present inventor is aware, and its differences and distinctions from the present invention, is provided below.

U.S. Pat. No. 981,937 issued on Jan. 17, 1911 to Enoch Ohnstrand, titled “Metal Door Frame,” describes a frame construction comprising a large number of relatively thin sheet metal components having a series of elongate bends therein to interlock with one another. The various components also include a series of interlocking tabs, with some mating surfaces being riveted together as well. The Ohnstrand construction is relatively light and does not provide the force resistant construction and componentry of the present frame system, and is not formed of a single monolithic member for each jamb or header component.

U.S. Pat. No. 1,913,716 issued on Jun. 13, 1933 to Charles F. Meilink et al., titled “Vault Frame Door,” describes a door and door frame system in which the stationary door frame is built up from multiple lengths of separate steel components, primarily in “angle iron” shapes. One angle is provided at each interior and exterior edge of the door opening, with further relatively light and thin components being required to tie the angles together. While the Meilink assembly provides adjustment for the thickness of the wall, such multiple piece frame construction is relatively weak. Moreover, the only protection provided by Meilink for the door edges, is by means of relatively light trim components spot welded to the frame members. The present invention provides complete protection for the edges of the door, by means of the specific cross sectional shape of the frame members.

U.S. Pat. No. 3,867,801 issued on Feb. 25, 1975 to Duane A. Hoefling, titled “Extruded Aluminum Door Frame,” describes a frame formed of a series of lengths having identical cross sectional shapes. However, the Hoefling frame attaches to the movable door itself, rather than providing a stationary frame secured to the structure in which the door is installed, as in the present invention. The aluminum extrusion of the Hoefling frame provides nowhere near the strength for the force resistance required in the environment of the present steel door and window frames, and moreover Hoefling does not disclose any specific structural details (inset door, joint coverage, etc.) which would provide resistance to blast, forced entry, and firearm effects.

U.S. Pat. No. 4,005,558 issued on Feb. 1, 1977 to John A. Barrison, titled “Extruded Door Frame,” describes frame components having symmetrical cross sectional shapes, unlike the asymmetrical shapes of the present frame components. The Barrison frame components include relatively sharp, thin flanges extending therefrom, which are driven between the framing studs and wall sheathing for installation. Such an installation cannot withstand the forces imparted by heavy blows and/or ballistics, as required by the State Department Standard 01.01 noted further above, which standards are met by the present framing system. Moreover, Barrison makes no disclosure of a door incorporating door edge and jamb gap coverage, as facilitated by the present frame invention with its inset external facing and lip.

U.S. Pat. No. 4,179,849 issued on Dec. 25, 1979 to Reinhold O. Kuffner, titled “Door Frame Assembly,” describes a multiple piece assembly having a series of stock angles and extrusions. The primary point of the large number of components is to allow their sequential assembly, thereby concealing all fastener heads beneath subsequently attached components. The Kuffner assembly is inherently weak, due to the large number of components and the fact that certain components are clamped by other members, rather than attached by threaded fasteners, pins, bolts, rivets, fusing (welding) or other attachment which is immune from slippage. Moreover, Kuffner clearly does not intend his frame to be highly force resistant, as the hinge clearly does not allow the door to be inset to resist jamb intrusion by a prying tool or the like.

U.S. Pat. No. 4,281,481 issued on Aug. 4, 1981 to Alan C. Wendt, titled “Fire Resistant Aluminum Door Frame Assembly,” describes a jamb and header configuration wherein each is formed of a complex series of components. The Wendt assembly is directed to allowing linear expansion of the jamb and header components in the event of heat expansion in a fire, thus precluding warping and jamming of the components against a door installed therein, and permitting the door to be opened. No means for covering the gap between the door and jamb is disclosed by Wendt, as his assembly is not directed to providing high security and force resistance.

U.S. Pat. No. 4,598,647 issued on Jul. 8, 1986 to Frederick F. Biedess, titled “Shrapnel Proof Door Frame,” describes a two piece jamb construction including a deliberate passage adjacent the exposed edge of the door. The passage is aligned with the gap between the door and jamb, so that ballistic fragments fired through the door and jamb gap will enter the passage without deflecting from the jamb components and entering the area to the opposite side of the door. While this construction provides a response to an anticipated problem in security type doors, it teaches away from the present single piece jamb construction and presents an inherently weaker structure which could possibly be broached by manual or blast forces. Moreover, the door and jamb relationships of the Biedess jamb invite prying tools to be inserted between door and jamb, which is not possible with the present force resistant door frame configuration.

U.S. Pat. No. 4,614,068 issued on Sep. 30, 1986 to Jerome M. Bergthold, titled “Extruded Door Frame Assembly,” describes jamb and header construction comprising two separate extruded pieces. A first or innermost piece secures between the sheathing panels adjacent to the door opening, with a second or outermost piece which distendibly snaps over the edges of the innermost piece, or over the outer edges of the sheathing. As noted further above, such multiple piece construction is inherently weaker than the monolithic, single piece construction of the present door frame jambs and headers. Moreover, no means for preventing forced entry or withstanding ballistic or blast effects is disclosed by Bergthold.

U.S. Pat. No. 4,949,771 issued on Aug. 21, 1990 to Fred A. Grisham et al., titled “Steel Security Door Frame,” describes a structural portion of a movable door, rather than the relatively stationary frame of the door opening, to which the present invention is directed. Accordingly, Grisham et al. do not disclose any means for insetting the exterior surface of the door in a stationary frame, nor for any door to jamb gap coverage, as provided by the present invention for providing resistance to forced entry and other forces.

U.S. Pat. No. 5,014,463 issued on May 14, 1991 to Marcel M. Barbier, titled “Combination Door And Door Frame,” describes a circular safe door configuration. The Barbier door and frame differ considerably from the present invention, in that (a) the circular configuration cannot be constructed from extruded lengths of material; (b) the door seats against the inner periphery of the surrounding wall, rather than fitting within a frame which is in turn secured within an opening through the wall; (c) the Barbier door opens inwardly, rather than outwardly; and (d) no protection against prying forces from forced entry is provided between the edge of the door and the adjacent peripheral wall.

U.S. Pat. No. 5,109,645 issued on May 5, 1992 to Carlo G. Bucci, titled “Frame Construction System,” describes relatively lightweight door and window framing members formed of various different sections of aluminum extrusions. Where aluminum is used, the joints are secured together mechanically for future disassembly, rather than being welded as in the present steel door and window frame construction. Bucci does not disclose any means for preventing forced entry or providing security against blast or other forces, as provided by the present door and window frames.

Finally, the present inventor is well acquainted with the Department of State Document SD-STD-01.01, Revision G (amended), dated Apr. 30, 1993, titled “Certification Standard—Forced Entry And Ballistic Resistance Of Structural Systems.” This document describes the performance requirements for door and window frames meeting the certification standard, although no specific structural requirements are described therein.

None of the above inventions and patents, taken either singularly or in combination, is seen to describe the instant invention as claimed. Thus a force resistant door and window framing system solving the aforementioned problems is desired.

### SUMMARY OF THE INVENTION

The present force resistant door and window framing system comprises opposed jamb and stile members, header members, and (in the case of windows) a sill member, with each of the members being formed as a single, homogeneous, monolithic length of extruded steel. Each of the door frame members are thus identical to one another, with identical asymmetrical cross sections; the window frame members are also identical to one another as well. Door and window frames constructed in accordance with the present invention meet the certification standards of U.S. Department of State Document SD-STD-01.01, Revision G (amended), which describes the performance standards for force resistant doors and windows to be incorporated in State Department structures. Door and window frames constructed in accordance with the present invention include means for precluding entry to the gap between the door and jamb or header, thus greatly reducing or precluding forced entry as well as blast or ballistic forces. The inset door relative to the frame, provides further protection against the use of a prying tool for forced entry.

Accordingly, it is a principal object of the invention to provide a force resistant door and window framing system meeting the certification standards of Department of State Document SD-STD-01.01, Revision G (amended), describing the performance standards for door and window framing systems in resisting forced entry and ballistic (firearm) forces.

It is another object of the invention to provide such a force resistant door and window framing system formed of a series of lengths of extruded or drawn steel members, with each of the members having identical asymmetrical cross sections to one another.

It is a further object of the invention to provide a force resistant door and window framing system in which the door frame components each comprise a single, homogeneous, monolithic length of material, and in which the window frame components comprise a similar length of extruded material with a single additional stop member.

Still another object of the invention is to provide a force resistant door and window system incorporating means for covering the gap between the door and door frame for further resistance to forced entry and blast effects, and further incorporating an inset door edge relative to the frame for further resistance to forced entry tools and forces.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a wall incorporating a force resistant door and window frame in accordance with the present invention.

FIG. 2 is a cross sectional view along line 2-2 of FIG. 1, showing a section through the hinge jamb assembly of the door.

FIG. 3 is a cross sectional view along line 3-3 of FIG. 1, showing a section through the door latch plate jamb assembly.

FIG. 4 is a cross sectional view along line 4-4 of FIG. 1, showing a section across the window and window stiles.

FIG. 5 is a cross sectional view of a prior art door jamb, showing its assembly from a large number of stock components.

FIG. 6 is a cross sectional view of a prior art window stile, showing its assembly from a large number of stock components.

Similar reference characters denote corresponding features consistently throughout the attached drawings.

### DETAILED DESCRIPTION OF THE PREFERRED EMBODIMENTS

The present invention comprises a force resistant door and window framing system which meets the standards of Department of State Document SD-STD-01.01, Revision G (amended), describing the performance standards for door and window framing systems in resisting forced entry and ballistic (firearm) forces. The present system is novel in that it meets and exceeds those standards using essentially a single extruded component for each frame member.

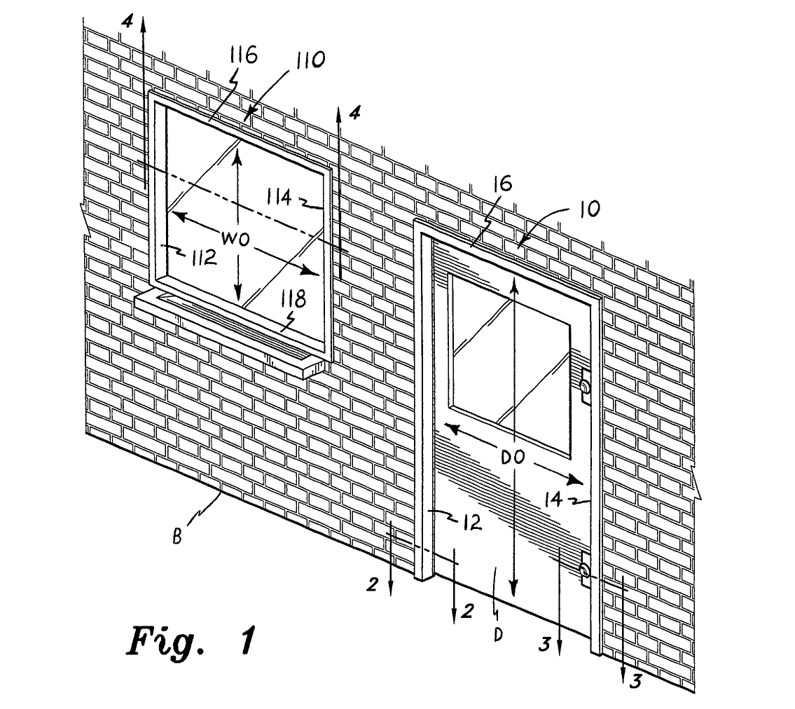

FIG. 1 illustrates an exemplary installation of a door frame 10 and window frame 110 respectively within door structural opening DO and window structural opening WO of a building structure B. The frame members 12, 14, and 16 of the door frame 110 are all formed as homogeneous, monolithically extruded steel members of identical asymmetrical cross sectional shape to one another, as they are extruded (which term includes other methods for continuously forming a material, e.g. hot and cold drawing, etc.) using a common die for each door frame component 12 through 16. The window frame members 112, 114, 116, and 118 are also homogeneous, monolithically extruded steel members formed using the same processes as used for the door frame members, but using a different common die for the window frame components 112 through 118. The rigid, monolithic frame members 12 through 16 comprising the door frame 10 are welded together at their mating ends, as are the window frame members 112 through 118, respectively forming unitary frame structures 10 and 110 which are highly resistant to forced entry, ballistic (firearms) , and blast forces, as described in detail further below.

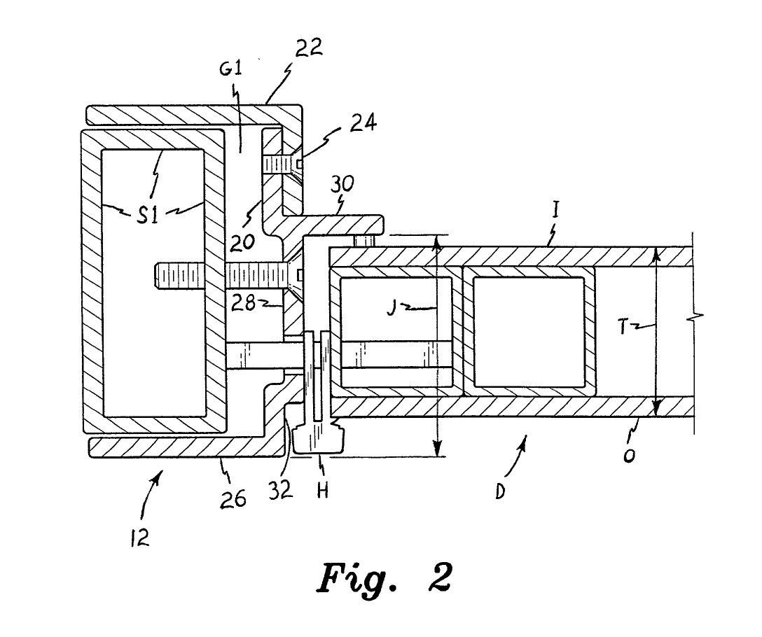

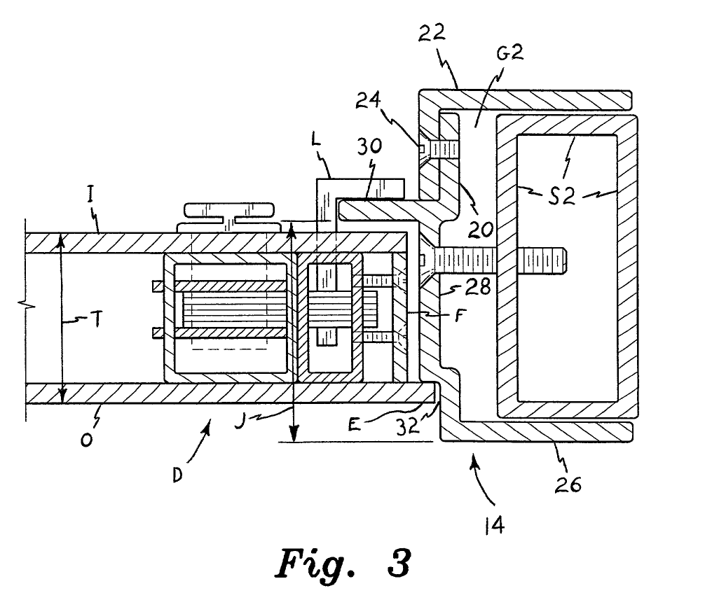

FIGS. 2 and 3 respectively illustrate cross sectional views of the hinge jamb member 12 and opposite striker plate jamb member 14 of the door frame 10. It will be seen that the two members 12 and 14 are mirror images of one another, due to their reversal to provide opposite side members for the door frame 10, but they each have identical asymmetrical cross sections when viewed from corresponding ends. The header 16, not shown in section, also has an identical cross section to the two jambs 12 and 14.

The hinge jamb member 12 and its opposite striker plate jamb member 14, respectively illustrated in section in FIGS. 2 and 3, each include an inwardly disposed (i. e., relative to the interior and exterior of the building) flange 20 extending therefrom, formed integrally with the jamb members 12 and 14 (and header member 16). This flange 20 provides for the attachment of a supplementary internal trim or reinforcement member 22, which may comprise an angle with one leg secured (e. g., using a screw 24, bolt, etc.) to the flange 20, and with the other leg extending beyond the inwardly facing side of a subframe member S1, S2, etc., or the associated wall structure. While the supplementary trim or reinforcement member 22 may not be required, it can be of value in precluding the possibility of withdrawing the entire door frame assembly 10, with its door D, outwardly from the door opening DO of the building.

Each frame member 12, 14, and 16 also includes a front flange 26 which extends laterally outwardly from the jamb plate 28 of the frame members, and formed integrally and monolithically therewith by the extrusion or drawing process. This front flange 26 is sufficiently wide to extend past any discontinuity or gap, e. g. discontinuities or gaps G1 and G2 between the respective door frame hinge and striker plate jamb components 12 and 14 and the structural opening defined by the subframe members S1 and S2 in FIGS. 2 and 3. This provides coverage for these areas, precluding the application of forced entry, ballistic (firearms), and/or at least moderate explosive forces to these gaps G1 and G2 in attempts to gain entry to the building structure.

The jamb plate 28 also includes an inwardly extending (i. e., toward the center of the door opening) door stop flange 30, also formed integrally and monolithically with the remainder of the respective jamb components 12 through 14 during the extrusion or drawing process. This door stop flange 30 provides means for stopping any inward movement of the door D past its latching position, as shown in FIG. 3 of the drawings. The identical door stop flange 30 of the opposite hinge jamb member 12 serves as a backup or blocking member in the event the hinge H is damaged, in order to prevent the door D from being pushed inwardly. The door stop flange 30 of the striker plate jamb 14 may also serve as a latch securing point for an external latch L, as shown in FIG. 3.

The door D intended for use with the present force resistant door frame 10 is also constructed to be force resistant, having a relatively thick steel inner face I and outer or front face O. The two panels or faces I and O define a door thickness T, with this door thickness T being somewhat less than the jamb width or distance J defined by the front flange 26 and door stop flange 30 parallel thereto. This results in the front or outer face O of the door D being inset or recessed from the plane of the front flange 26 when the door D is closed against or adjacent to the door stop flange 30, as is shown clearly in FIGS. 2 and 3 of the drawings. Recessing the door D within the two jambs 12 and 14 precludes any means for forcing a tool (or explosively driven object or force) laterally between the door D and jambs 12 and 14, for greater security for the door frame assembly 10 and security door D.

The present jamb extrusions 12 and 14 (and the unshown, but identical, header member 16) incorporate an inset corner or notch 32 at the juncture of the front flange 26 and jamb plate 28. The outer or front face O of the door D includes a force resistant plate extension E which extends beyond the latch face F of the door D and which seats within the inset corner or notch 32 of the striker plate jamb member 14 when the door D is closed, as shown in FIG. 3 of the drawings. This coverage of the gap between the latch face F of the door D and the adjacent jamb plate 28, precludes any inward application of force (tools, ballistic rounds, etc.) between the latch face F of the door D and the adjacent jamb plate 28 when the door D is closed, as shown in FIG. 3.

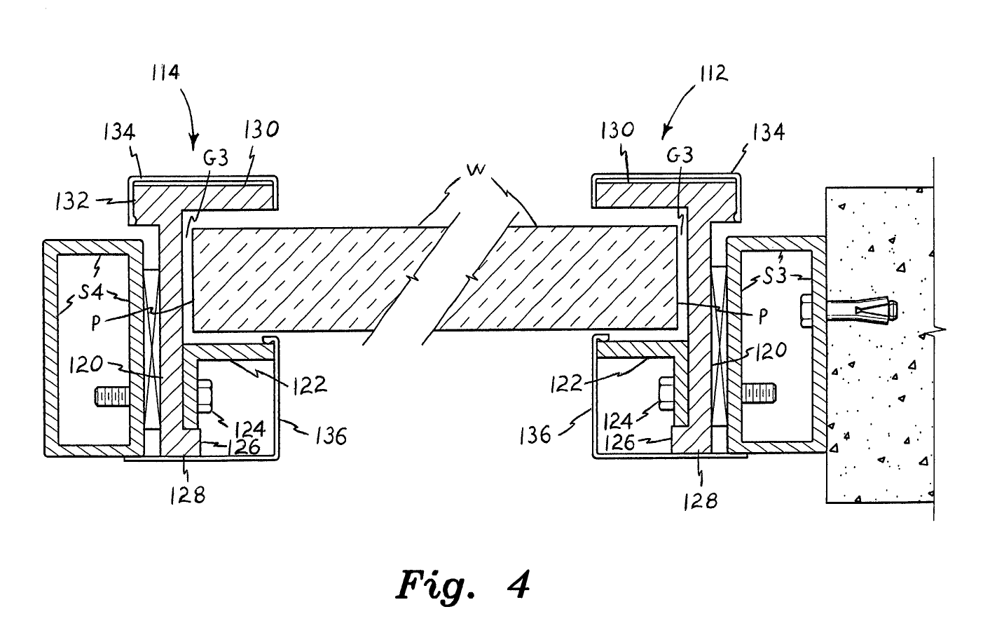

FIG. 4 illustrates a cross section view along line 4-4 through the window frame 110 of FIG. 1. The four window frame members of FIG. 1 comprise a first side stile 112 and opposite second side stile 114, with an upper header 116 and a lower sill 118 opposite the header 116. Each of these components 112 through 118 is formed (extruded, drawn, etc.) using a common die shape to have identical asymmetrical cross sections, as noted further above in the discussion of FIG. 1. FIG. 4 provides a detailed illustration of the cross sectional shape of the two stile members 112 and 114, with it being understood that the unshown sections of the header 116 and sill 118 are identical and interchangeable with the stile sections 112 and 114, depending upon their cut lengths. The lengths 112 through 118 are welded together to form a completed window frame 110, generally in the manner of the door frame 10.

The cross section view of FIG. 4 clearly shows the inwardly extending (i. e., toward the interior of the building structure) flange 120, which is formed as an integral and monolithic portion of the overall frame members as exemplified by the two stile members 112 and 114. These inwardly extending flanges 120 extend beyond the window glass or pane W, to provide an attachment area for an internal pane stop 122 which is secured (e. g., by bolt 124, etc.) behind the window pane W to preclude inward movement of the window W. The bolt 124 may also be used to secure the stiles 112 and 114, as well as the header and sill, to the adjacent subframe members S3 and S4, as shown in FIG. 4.

The pane stop 122 comprises an elongate angle similar to the supplemental reinforcement angle 22 of the door frame system of FIGS. 2 and 3. However, the pane stop 122 is a required separate component for the window frame 110, as the window pane W is inserted into the frame 110 from the back or interior side, with one leg of the pane stop 122 disposed adjacent the inner or back periphery P of the window panel W and the opposite leg being secured to the inwardly extending flange 120 of the frame member 112 through 118.

The inwardly extending flange 120 provides further security against inward displacement of the window W, by means of a stop bar 126 integrally formed along the distal edge 128 of the inward flange 120. This stop bar extends inwardly past the edge of the pane stop angle 122, to provide further resistance against inward

The window frame members 112 through 120 each include similar means for preventing inwardly directed forces along the frame 110, as the door frame members 12 through 16. Each of the frame members, e. g., the stiles 112 and 114 of FIG. 4, have a laterally inwardly extending (i. e., toward the center of the window opening) front flange 130, which extends across the discontinuity or gap G3 defined by the window frame members and the periphery P of the window pane W. (These gaps G3 are illustrated without seals therein for clarity in the drawing Figure, but it will be understood that some form of seals will normally be installed between the window periphery P and the frame members 112 through 118.) The laterally inwardly extending flange 130 is formed integrally and monolithically with the remainder of the window frame extrusion to extend over the periphery P of the window pane W, thereby covering the gap G3 and precluding the application of force (tools, firearm ballistics, etc.) to the gap G3.

The window frame components 112 through 118, e. g. the two stile members 112 and 114 of FIG. 4, also include a laterally outwardly extending front flange 132 formed integrally and monolithically therewith, opposite the flange 130. This outwardly extending flange 132 covers the discontinuity or gap G4 occurring between the frame members and the adjacent subframe members, e. g., stile members 112 and 114 and respective subframe members S3 and S4. This serves the same function as that of the lateral gap covering flanges 26 of the door frame members, i. e., precluding force entry into the gap G4 between the window frame and subframe.

It will be understood that the present window frame system 110 comprising stile, header, and sill members 112 through 118 is formed as relatively thick and heavy extrusions, and as such it may be desirable to cover or conceal their surfaces (and attachments, such as the inner pane stops 122 and bolts 124). Accordingly, decorative outer and inner trim components 134 and 136 comprising relatively thin, lightweight aluminum, plastic, or other extruded or otherwise formed material, may be applied respectively to the outer flanges 130 and 132 and distal ends 128 of the inwardly extending flanges 120 and accompanying stop angles 122, to provide a more pleasing appearance. The trim panels 134 and 136 may be secured to their respective window frame components by conventional means, e. g., clipping in place, adhesives, etc., as desired.

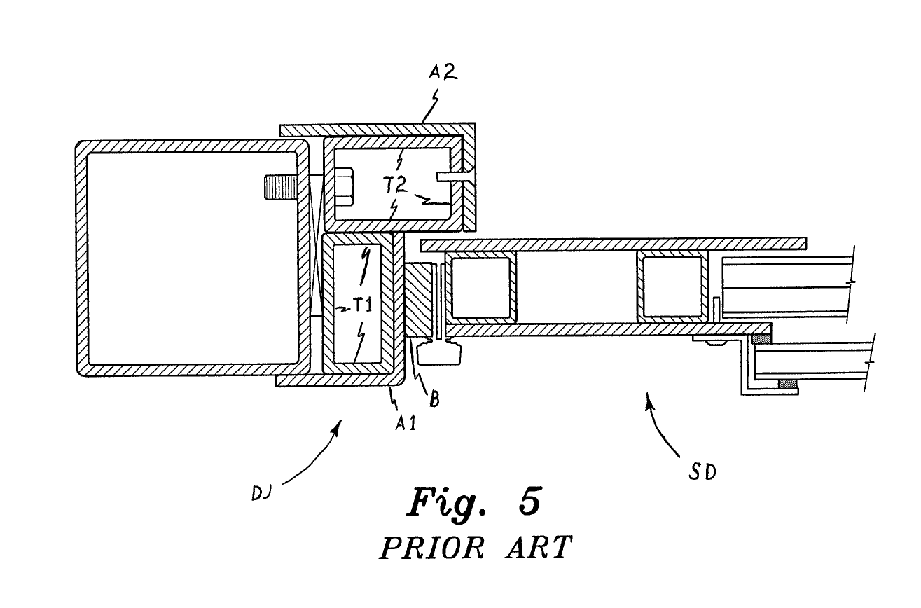

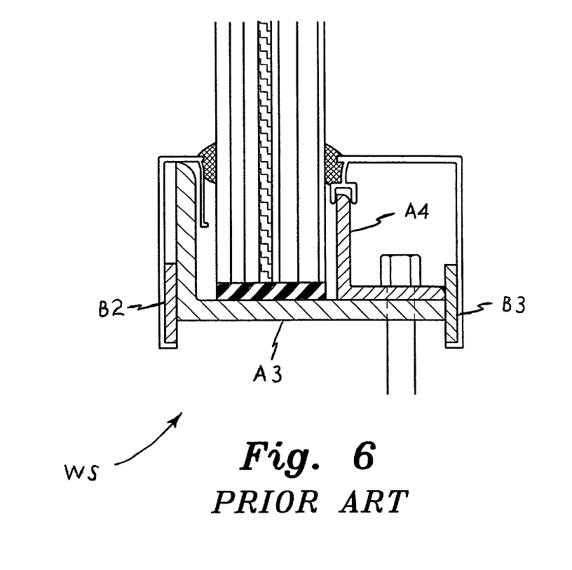

FIGS. 5 and 6 respectively illustrate conventional hinge jamb and window frame constructions of the prior art, wherein the frame members are formed of a relatively large number of stock components. In FIG. 5, a door jamb member DJ is illustrated for the hinge side of the security door SD. (The door SD includes window panels therein, which may also be incorporated with the extruded security door frame members of the present invention, if so desired.) The door jamb member DJ is formed of five separate stock steel shapes, welded together to form the completed door jamb assembly. Two rectangular tube components T1 and T2 are used to form the basic shape, with two separate angle components A1 and A2 used to secure the assembly to the subframe member. Finally, a length of bar stock B is used for attachment of the hinge.

FIG. 6 illustrates a prior art window frame construction comprising a similar series of stock steel shapes, welded together. In FIG. 6, a window stile WS is formed of a larger angle A3 and a smaller angle A4, both formed from stock shapes. A pair of steel bars or straps B2 and B3 are welded together with the two angles A3 and A4 to complete the structure.

While some of the same functions provided by the present security door and window frames are provided by the prior art frames, primarily in their resistance to applied forces in general, it must be noted that these prior art frames are considerably less efficient than the essentially single piece frames of the present invention. First of all, by forming the prior art frames of stock materials, the constructor is limited to the sizes and wall thicknesses available, and in most cases will likely have to go to a larger size and/or thickness than optimum, due to the limited stock sizes and thicknesses. Secondly, the requirement that the parts be assembled together results in double, and sometimes triple, wall thicknesses at adjoining parts, resulting in considerably greater weight for the part. Thirdly, the use of welding to assemble the prior art stock components results in the welded joints being relatively weaker than the metal of the stock components used for the assembly. Finally, the requirement that the multiple components be welded together along their entire lengths, results in relatively long assembly times using skilled labor, thus driving up the cost considerably even when the use of stock, off the shelf components is considered.

In conclusion, the present force resistant door and window framing system provides a significant advance over earlier structures of the prior art used in such environments. While the cost of forming (extruding, drawing, etc.) the specialized cross sectional shapes used for the present door and window framing system may be somewhat higher than the cost of the stock shapes used in the prior art built-up frames, this higher initial cost is more than made up by the ease and rapidity of fabrication of door and window frames, installation of doors and windows therein, and final installation of the assembly in an opening or passage in a building structure.

The only welding required with the present framing invention, are relatively short welds used to join each section (e. g., stile, header, and sill, etc.) to produce the finished frame. No lengthy welds along the length of the frame are required using the present framing system. Yet, the present frame system is more than capable of meeting the performance requirements outlined in Department of State Document SD-STD-01.01, Revision G (amended), which describes the performance standards for force resistant doors and windows to be incorporated in State Department structures. Accordingly, the present force resistant door and window frames will find great favor in such construction, and wherever high strength, force resistant door and window framing is required.

It is to be understood that the present invention is not limited to the embodiments described above, but encompasses any and all embodiments within the scope of the following claims.

I claim:

1. A force resistant frame for installing in a structural opening, comprising:
a plurality of frame members;
each of said frame members comprising a homogeneous, monolithically extruded steel member having an asymmetrical cross sectional shape; and
each of said frame members being welded together and forming a frame structure incorporating means for resisting forced entry, ballistic firearm, and blast forces.

2. The force resistant frame according to claim 1, wherein said plurality of frame members comprises:
a hinge jamb;
a striker plate jamb opposite said hinge jamb;
a header above said hinge jamb and said striker plate jamb;
said hinge jamb, said striker plate jamb, and said header each having an identical cross sectional shape to one another and adapted for attachment to a door subframe of a building in order to define a door frame structure having an opening for a door.

3. The force resistant frame according to claim 2, further including:
an inwardly disposed flange extending from each said jamb and said header adapted for extending towards the interior of the building; and
an internal reinforcement secured to said flange of at least one of said jamb and said header, for precluding outward movement of said door frame structure.

4. The force resistant frame according to claim 2, wherein each said jamb and said header further include a front flange extending laterally outwardly and formed integrally and monolithically therewith, for covering a discontinuity between said door frame structure and a door subframe, thereby precluding application of force to said discontinuity for separating said door frame structure from the door subframe.

5. The force resistant frame according to claim 2, wherein each said frame member further includes:
a front flange extending laterally outwardly normal to said jambs and said header, respectively, and formed integrally and monolithically with each said jamb and said header;
an inwardly disposed door stop flange formed integrally and monolithically with each said jamb and said header, for stopping inward movement of a door;
said front flange and said door stop flange being defined in parallel, spaced apart planes; and
wherein said jambs and said header, respectively, are recessed from said front flange so that a force resistant door having a front face and a thickness less than said distance between each said plane of said front flange and said door stop flange is insulated from a lateral application of force between said door and said jamb.

6. The force resistant frame according to claim 2, further including:
a force resistant door having a latch edge face and a force resistant plate extending beyond said latch edge face;
a jamb plate formed integrally and monolithically with each said jamb and said header, generally parallel to said latch edge face of said door when said door is closed;
a front flange extending laterally outwardly and formed integrally and monolithically with each said jamb and said header; and
an inset corner disposed between said jamb plate and said front flange of each said jamb and said header, for accepting said force resistant plate of said door for precluding inward application of force between said door and said jamb.

7. The force resistant frame according to claim 1, wherein said plurality of frame members comprises:
a first side stile;
a second side stile opposite said first side stile;
a header above said first and second side stiles;
a sill opposite said header;
said first side stile, said second side stile, said header, and said sill each having an identical cross sectional shape to one another and being joined to define a window frame structure adapted for attachment to a window opening of a building;
each said stile, said header, and said sill each having an inwardly extending flange formed integrally and monolithically therewith; and
an internal pane stop secured to each said inwardly extending flange, for precluding inward movement of a pane within said window frame structure.

8. The force resistant window frame according to claim 7, wherein:
said inwardly extending flange of each said stile, said header, and said sill further includes a distal edge; and
a stop bar formed integrally and monolithically with and extending inwardly from said distal edge of each said inwardly extending flange adjacent said internal reinforcement, for precluding inward movement of said internal pane stop.

9. The force resistant window frame according to claim 7, further including:
at least one force resistant pane having a periphery secured within said window frame structure;
said at least one pane and said window frame structure defining a discontinuity therebetween; and
a front flange extending laterally inwardly and formed integrally and monolithically with each said stile, said header, and said sill, and extending over said periphery of said at least one pane, for covering said discontinuity and precluding application of force therein.

10. The force resistant window frame according to claim 7, further including:
said window frame structure and the structural opening define a discontinuity therebetween; and
each said stile, said header, and said sill further include a front flange extending laterally outwardly and formed integrally and monolithically therewith, for covering said discontinuity and precluding application of force therein.

11. A force resistant door frame for installing in a structural opening, comprising:
a hinge jamb;
a striker plate jamb opposite said hinge jamb;
a header;
said hinge jamb, said striker plate jamb, and said header each comprising a homogeneous, monolithically extruded steel member having an identical asymmetrical cross sectional shape to one another; and
said hinge jamb, said striker plate jamb, and said header being welded together and forming a door frame structure incorporating means for resisting forced entry, ballistic firearm, and blast forces.

12. The force resistant door frame according to claim 11, further including:
an inwardly disposed flange extending from each said jamb and said header; and
an internal reinforcement secured to said flange of at least one of said jamb and said header, for precluding outward movement of said door frame structure.

13. The force resistant door frame according to claim 11, wherein:
said door frame structure and the structural opening define a discontinuity therebetween; and
each said jamb and said header further include a front flange extending laterally outwardly and formed integrally and monolithically therewith, for covering said discontinuity and precluding application of force therein.

14. The force resistant door frame according to claim 11, further including:
a front flange extending laterally outwardly and formed integrally and monolithically with each said jamb and said header;
an inwardly disposed door stop flange formed integrally and monolithically with each said jamb and said header, for stopping inward movement of a door;
said front flange and said door stop flange each defining a plane having a distance therebetween; and
a force resistant door having a front face and a thickness less than said distance between each said plane of said front flange and said door stop flange, with said front face of said door being inset from said front flange when said door is immediately adjacent said door stop flange for precluding lateral application of force between said door and said jamb.

15. The force resistant door frame according to claim 11, further including:
a force resistant door having a latch edge face and a force resistant plate extending beyond said latch edge face;
a jamb plate formed integrally and monolithically with each said jamb and said header, generally parallel to said latch edge face of said door when said door is closed;
a front flange extending laterally outwardly and formed integrally and monolithically with each said jamb and said header; and
an inset corner disposed between said jamb plate and said front flange of each said jamb and said header, for accepting said force resistant plate of said door for precluding inward application of force between said door and said jamb.

16. A force resistant window frame for installing in a structural opening, comprising:
a first side stile;
a second side stile opposite said first side stile;
a header;
a sill opposite said header;
said first side stile, said second side stile, said header, and said sill each comprising a homogeneous, monolithically extruded steel member having an identical asymmetrical cross sectional shape to one another;
said first side stile, said sill, said second side stile, and said header being welded together and forming a window frame structure incorporating means for resisting forced entry, ballistic firearm, and blast forces;
each said stile, said header, and said sill each having an inwardly extending flange formed integrally and monolithically therewith; and
an internal pane stop secured to each said inwardly extending flange, for precluding inward movement of a pane within said window frame structure.

17. The force resistant window frame according to claim 16, wherein:
said inwardly extending flange of each said stile, said header, and said sill further includes a distal edge; and
a stop bar formed integrally and monolithically with and extending inwardly from said distal edge of each said inwardly extending flange adjacent said internal reinforcement, for precluding inward movement of said internal pane stop.

18. The force resistant window frame according to claim 16, further including:
at least one force resistant pane having a periphery secured within said window frame structure;
said at least one pane and said window frame structure defining a discontinuity therebetween; and
a front flange extending laterally inwardly and formed integrally and monolithically with each said stile, said header, and said sill, and extending over said periphery of said at least one pane, for covering said discontinuity and precluding application of force therein.

19. The force resistant window frame according to claim 16, further including:
said window frame structure and the structural opening define a discontinuity therebetween; and
each said stile, said header, and said sill further include a front flange extending laterally outwardly and formed integrally and monolithically therewith, for covering said discontinuity and precluding application of force therein.
